(19) United States
(12) Patent Application Publication
(10) Pub. No.: US 2004/0189580 A1
(43) Pub. Date: Sep. 30, 2004

(54) Liquid crystal display device

(75) Inventors: Katsuyoshi Hiraki, Kawasaki (JP); Tetsuya Kobayashi, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU DISPLAY TECHNOLOGIES CORPORATION

(21) Appl. No.: 10/807,987

(22) Filed: Mar. 24, 2004

(30) Foreign Application Priority Data
Mar. 31, 2003 (JP) 2003-095288

(51) Int. Cl. G09G 3/36

(52) U.S. Cl. 345/98

(57) ABSTRACT

At least one of an output corresponding to a maximum tone and an output corresponding to a minimum tone in a data driver of a liquid crystal display device is used only for image data that has undergone data correction for improving response speed of liquid crystal, and consequently, data correction for improving response speed can be made in all areas.

### CROSS-REFERENCE TO RELATED APPLICATIONS

This application is based upon and claims the benefit of priority from the prior Japanese Patent Application No. 2003-095288, filed on Mar. 31, 2003, the entire contents of which are incorporated herein by reference.

### BACKGROUND OF THE INVENTION

1. Field of the Invention

The present invention relates to a liquid crystal display device, and more particularly, to high-speed response driving of the liquid crystal display device.

2. Description of the Related Art

In recent years, in response to a demand for energy saving and space saving, notebook PCs (personal computers) and desktop PCs having a liquid crystal display device are in wide use. Further, in order to improve display properties of moving images and the like, higher-speed response is also demanded in liquid crystal display devices provided in notebook PCs, desktop PCs, and the like. For this purpose, efforts to improve response speed of liquid crystal has been conventionally made in terms of material properties of liquid crystal, the arrangement and structure of display elements, and a driving method of a display device.

A high-speed response driving method in conventional liquid crystal display devices is disclosed in, for example, the patent document 1 (Japanese Patent Application Laid-open No. 2001-265298), the patent document 2 (Japanese Patent Application Laid-open No. 2002-107694, the patent document 3 (Japanese Patent Application Laid-open No. 2002-297104), and so on.

However, the high-speed response driving in the conventional liquid crystal display devices has various problems as explained below.

<First Problem>

There exist areas where data correction for improving the response speed of liquid crystal cannot be made and areas where response at an intended speed cannot be attained even when the data correction is made.

FIG. 7A and FIG. 7B, which are charts to explain the first problem presented above, show the basic concept of a high-speed response driving method.

It is assumed that an input signal inputted to a liquid crystal display device has changed, for example, from a tone A (signal level SA) to a tone B (signal level SB) at a timing of a frame F1 as shown in FIG. 7A.

At this time, luminance has to change from a luminance level BA of the tone A to a luminance level BB of the tone B within one frame period. In other words, it has to reach the luminance level BB of the tone B at the timing of a frame F2. However, due to the slow response of liquid crystal as shown by the solid line LB, luminance does not reach the luminance level BB of the tone B within one frame period.

Here, when the input signal is changed from the tone A to a tone C (signal level SC) at the timing of the frame F1 as shown in FIG. 7A, it is seen that the luminance changes to the luminance level BB of the tone B at the timing of the frame F2 after one frame period has passed. Therefore, when the input signal is to be changed from the tone A to the tone B, data is corrected in such a manner that the tone C is inputted only during a transit frame period as shown in FIG. 7B. This allows the luminance to change from the luminance level BA of the tone A to the luminance level BB of the tone B within one frame period.

However, when the tone B after the change corresponds to the maximum luminance level, a tone of higher luminance level than this luminance level does not exist, and therefore, there arises a problem that data correction cannot be made. Incidentally, in the above-described explanation, the case where the luminance changes from the lower tone A to the higher tone B is shown as an example, but the same applies to a case where the luminance changes from a higher tone to a lower tone. Hereinafter, the case where the luminance similarly changes from a lower tone to a higher tone will be shown as an example.

<Second Problem>

Deviation in data correction amount occurs due to the co-use of error diffusion.

FIG. 8 is a chart to explain the second problem. FIG. 8 shows response properties when a correction tone for changing the luminance from the tone A to the tone B within one frame period is a tone (C+1) that is different from the tone C by one tone. The difference only by one tone results in a luminance higher than the intended luminance.

A typical method of the error diffusion will be explained based on FIG. 9. In the error diffusion, the tone C and the tone (C+1) are combined for display in order to attain the luminance level of a tone C′ that is a mean tone between the tone C and the tone (C+1), and they are averaged by a viewer's vision to attain the luminance level of the tone C′.

Therefore, when the correction tone for changing the luminance from the tone A to the tone B within one frame period is the tone C′, one of the tone C and the tone (C+1) is selected as an actually used correction tone. This may possibly result in a correction amount larger than necessary as shown in FIG. 8.

<Third Problem>

When backlights are impulse-driven, there occurs difference in luminance depending on positions on the screen.

FIG. 10A, FIG. 10B, and FIG. 10C are charts to explain the third problem.

FIG. 10A shows the positional relationship between display lines L1 and L2 on a panel 101, and FIG. 10B shows the correlation between time and response (luminance level) when the luminance level of the display lines L1, L2 are changed from the tone A to the tone B.

In a liquid crystal display device, write is normally executed line by line starting from a line in an upper area of the screen in sequence. Therefore, the response start time at which the luminance level starts to change in response to the execution of the write is different between the display lines L1 and L2 shown in FIG. 10A (see FIG. 10B).

FIG. 10C shows a chart in which a backlight-on period when the backlights are impulse-driven here is added to FIG. 10B. An amount of light of the display line L1 in a backlight-on period T_{BL} is S+ΔS, and an amount of light of the display line L2 is S. Thus, even in the same tone change, a total light amount becomes different in the different display lines L1, L2, so that luminance differs depending on positions on the screen.

<Fourth Problem>

Data correction cannot be made properly due to change in temperature difference between the temperature detected by a temperature sensor and the temperature of a panel surface while power is supplied (during a power-on time).

FIG. 11, which is a chart to explain the fourth problem, shows a temperature Ts detected by a temperature sensor and a temperature Tp of a panel surface in a liquid crystal display device. Temperature detection by the temperature sensor or the like is required since response properties of liquid crystal change depending on an ambient temperature, but since a liquid crystal panel is a display device, the temperature sensor cannot be disposed on the panel.

Therefore, the temperature sensor is disposed at an arbitrary place in the device other than the surface of the panel. This causes a temperature difference ΔT between the temperature Tp of the panel surface and the temperature Ts detected by the temperature sensor as shown in FIG. 11. Data correction in consideration of this temperature difference ΔT realizes proper high-speed response driving.

However, the temperature difference between the temperature Tp and the temperature Ts during a period from the power-on time to a stable period is different from the temperature difference ΔT in the stable period as shown in FIG. 11. Therefore, if data correction is made based on the temperature difference ΔT of the stable period, the data correction during the period from the power-on time to the stable period is not proper.

### SUMMARY OF THE INVENTION

An object of the present invention is to realize improved response speed of liquid crystal in a liquid crystal display device.

According to the present invention, at least one of an output corresponding to a maximum tone and an output corresponding to a minimum tone in a data driver of a liquid crystal display device is used only for image data that has undergone data correction for improving response speed of liquid crystal. According to the present invention, the output corresponding to the maximum tone and the output corresponding to the minimum tone are not used for image data that has not undergone the data correction. This makes it possible to make data correction for all the image data.

### BRIEF DESCRIPTION OF THE DRAWINGS

FIG. 1 is a diagram showing a configuration example of a liquid crystal display device according to an embodiment of the present invention;

FIG. 2 is a diagram showing a configuration example of an image/timing processing section in a first embodiment;

FIG. 3 is a chart showing another example of an output level in the first embodiment;

FIG. 4 is a diagram showing a configuration example of an image/timing processing section in a second embodiment;

FIG. 5 is a chart to explain a third embodiment;

FIG. 6A and FIG. 6B are a diagram and a chart to explain a fourth embodiment;

FIG. 7A and FIG. 7B are charts to explain a first problem;

FIG. 8 is a chart to explain a second problem;

FIG. 9 is a chart showing a typical method of error diffusion;

FIG. 10A, FIG. 10B, and FIG. 10C are charts to explain a third problem; and

FIG. 11 is a chart to explain a fourth problem.

### DETAILED DESCRIPTION OF THE PREFERRED EMBODIMENTS

Hereinafter, embodiments of the present invention will be explained based on the drawings.

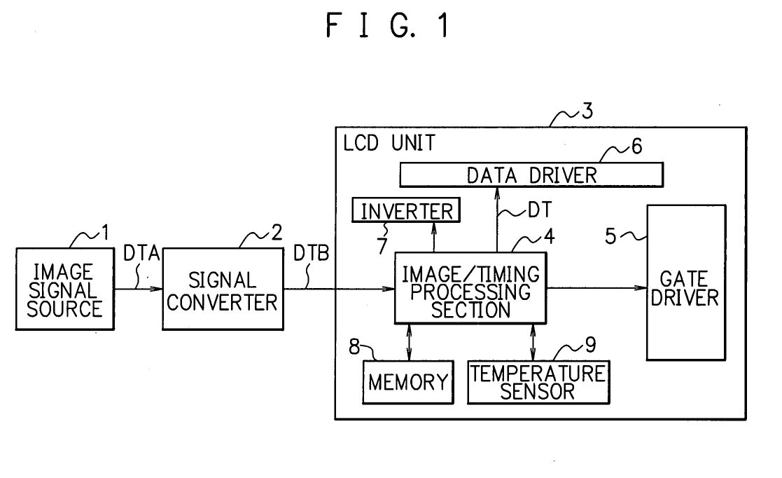

FIG. 1 is a block diagram showing a configuration example of a liquid crystal display device according to an embodiment of the present invention.

In FIG. 1, 1 denotes an image signal source of a PC, a VIDEO player, a DVD player, or the like. 2 denotes a signal converter that converts an image signal DTA supplied from the image signal source 1 to image data DTB processable in a liquid crystal display device 3.

The liquid crystal display device 3 has an image/timing processing section 4, a gate driver 5, a data driver 6, an inverter 7, a memory 8, a temperature sensor 9, and a not-shown display part. Based on the image data DTB supplied from the signal converter 2, the image/timing processing section 4 generates control signals for controlling the respective circuits in the liquid crystal display device 3, a clock signal, and so on to supply these signals, and supplies to the data driver 6 and so on the image data DTB or image data obtained by data correction of the image data DTB.

The gate driver 5 drives each gate line of the not-shown display part based on the control signal and clock signal supplied from the image/timing processing section 4, and consequently, the plural gate lines provided in the display part are driven in sequence starting from an upper area of a screen of the display part.

The data driver 6 applies a voltage commensurate with the image data on each data line of the display part based on the control signal, the clock signal, the image data, or the like supplied from the image/timing processing section 4.

Here, the not-shown display part has a plurality of gate lines and a plurality of data lines arranged in matrix, and pixels for displaying an image are disposed at intersections of the gate lines and the data lines. The aforesaid gate driver 5 and data driver 6 control the gate lines and the data lines to drive, so that an image pertaining to the image data supplied from the image/timing processing section 4 is displayed on the display part.

The inverter 7 converts a DC power supply to an AC power supply to feed it to backlights of the liquid crystal display device and turns on/off (impulse-drives) the backlights according to an instruction from the image/timing processing section 4. The memory 8 stores the image data DTB of a preceding frame, and the temperature sensor 9, which is provided at an arbitrary place other than the display part in the device, measures the temperature.

—First Embodiment—

A first embodiment of the present invention to be explained below is to solve the aforesaid first problem.

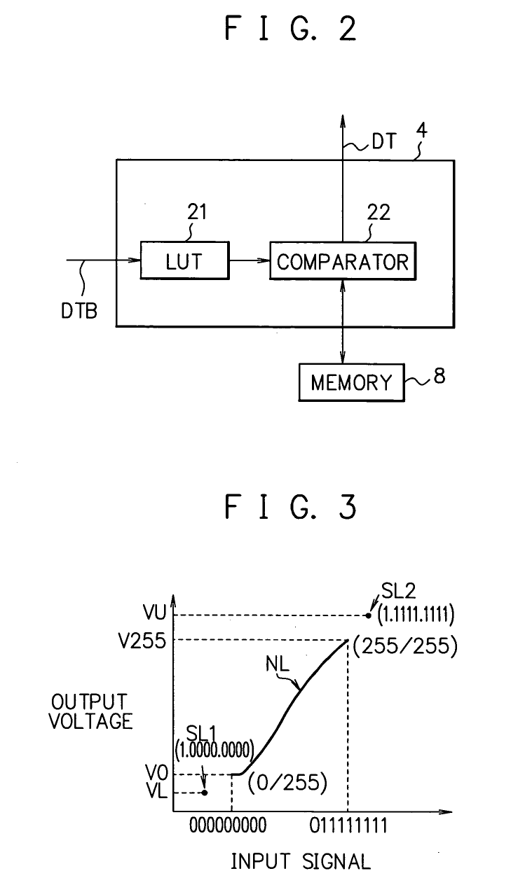

FIG. 2 is a diagram showing a configuration example of an image/timing processing section 4 in the first embodiment. The image/timing processing section 4 has a lookup table (LUT) 21 and a comparator 22.

In a case of image data DTB of, for example, 8 bits, the LUT 21 is intended for converting the inputted image data DTB of tones 0 to 255 to 256 kinds of tone levels using the data of the tones 1 to 254 supplied to liquid crystal. In the LUT 21, the data (254 pieces) of the tones 1 to 254 are used to express 256 kinds of tone levels, for example, in a similar manner to the aforesaid error diffusion method shown in FIG. 9. Note that the data of the tone 0 and the data of the tone 255 are used only for data correction for improving response speed in this embodiment.

The comparator 22 compares data of a frame (n−1) (n is a natural number) stored in the memory 8 and data of a frame n outputted by the LUT 21, and subjects the data of the frame n to the data correction for improving response speed according to the comparison result to output the corrected data as data DT. As described above, all the data of the tones 0 to 255 are used for the data correction.

As described above, according to the first embodiment, when data of the minimum tone and the data of the maximum tone, for example, the data of the tone 0 and the data of the tone 255 in the case of the image data DTB of 8 bit, are used only for the data correction for improving response speed. Consequently, the aforesaid first problem is solved, so that the data correction for improving response speed can be made in all the areas. This makes it possible to improve response speed of liquid crystal in the liquid crystal display device.

Note that the data of the tone 0 and the data of the tone 255 are not used as the displayed tone levels in the above-described first embodiment, so that the tone expression as the liquid crystal display device 3 is decreased from 256 tone levels by the data of the tones 0 to 255 to 254 tone levels by the data of the tones 1 to 254, resulting in the reduction by two in the number of tone expressions.

As a method of solving this, available is a method of using, as the data driver 6, data drivers having an output VU corresponding to a higher luminance than the luminance of the tone 255 and an output VL corresponding to a lower luminance than the luminance of the tone 0 as shown in FIG. 3. FIG. 3 is a chart showing another example of the output level in the first embodiment, and there exist the output VU corresponding to a luminance SL2 that is higher than the luminance of the tone 255 corresponding to an output V255 and the output VL corresponding to a luminance SL1 that is lower than the luminance of the tone 0 corresponding to an output V0.

When such output levels are used, for example, 1 bit that is a special output control bit (the most significant bit in FIG. 3) for causing the outputs VU, VL to be outputted is provided in addition to the conventional 8 bit data DT. Then, when the special output control bit is “0”, normal outputs (V0 to V255) are outputted. In a case where the special output control bit is “1”, the output VL and the output VU are outputted when the data DT is “00000000” and when the data DT is “11111111”, respectively. In this manner, the object here can be realized.

The configuration as described above can solve the first problem without decreasing the number of the tone expressions of the liquid crystal display device 3.

Further, in the above-described first embodiment, the data of the maximum tone and the data of the minimum tone are both used only for the data correction for improving response speed, but only one of them may be used according to properties and so on of the liquid crystal display device.

Further, in the above-described first embodiment, the case of the image data DTB of 8 bit is shown as an example, but the number of bits of the image data DTB is arbitrary.

Further, one output VU corresponding to the higher luminance than the luminance of the maximum tone and one output VL corresponding to the lower luminance than the luminance of the minimum tone are provided in FIG. 3, but each of them may be a plurality of different outputs. When the number thereof is plural, the number of the special output control bits is increased.

—Second Embodiment—

Next, a second embodiment of the present invention will be explained.

The second embodiment to be explained below is to solve the aforesaid second problem.

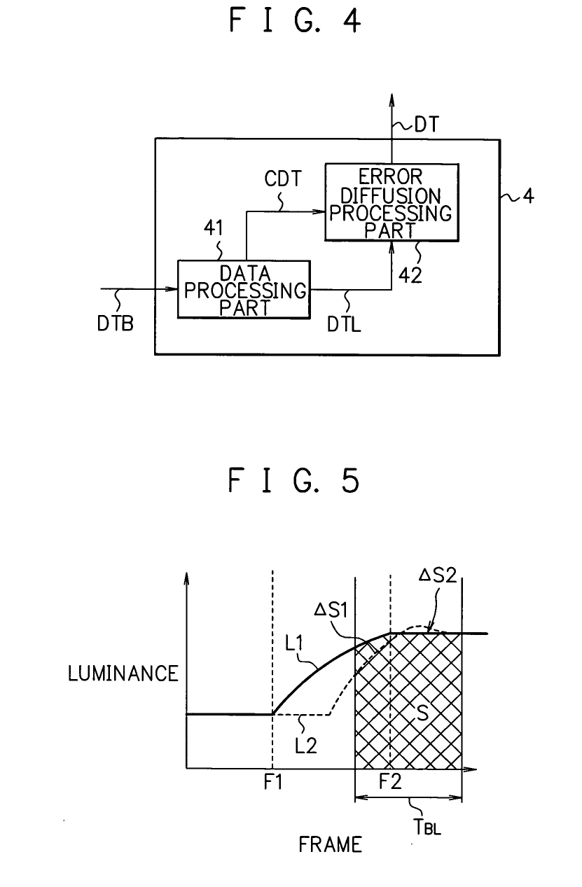

FIG. 4 is a diagram showing a configuration example of an image/timing processing section 4 in the second embodiment. The image/timing processing section 4 has a data processing part 41 having a function of the comparator 22 shown in FIG. 2 and an error diffusion processing part 42.

The data processing part 41 compares data of a frame (n−1) stored in a memory 8 and image data DTB of a frame n and subjects the image data DTB of the frame n to data correction for improving response speed according to the comparison result to output the corrected data as data CDT. Further, when the data CDT is data that has undergone the data correction, the data processing part 41 outputs to the error diffusion processing part 42 a control signal DTL that is set to high level for prohibiting the processing in the error diffusion processing part 42.

The error diffusion processing part 42 executes processing involved in the error diffusion as shown, for example, in FIG. 9, using the data CDT. However, when high level is set for the control signal DTL, the execution of the processing involved in the error diffusion is prohibited.

As described above, according to the second embodiment, when the data CDT is data resulting from the image data DTB that has undergone the data correction for improving response speed, the control signal DTL is set to high level to prohibit the processing of the data CDT in the error diffusion processing part 42. Consequently, the aforesaid second problem is solved, so that the occurrence of deviation in a data correction amount can be prevented. This can realize improved response speed of liquid crystal in the liquid crystal display device.

—Third Embodiment—

Next, a third embodiment of the present invention will be explained.

The third embodiment to be explained below is to solve the aforesaid third problem.

In the third embodiment, a data correction amount for improving response speed is adjusted for each of display lines L1, L2 of a display part (panel) of a liquid crystal display device, more concretely, according to a difference in the response start time as shown in FIG. 5.

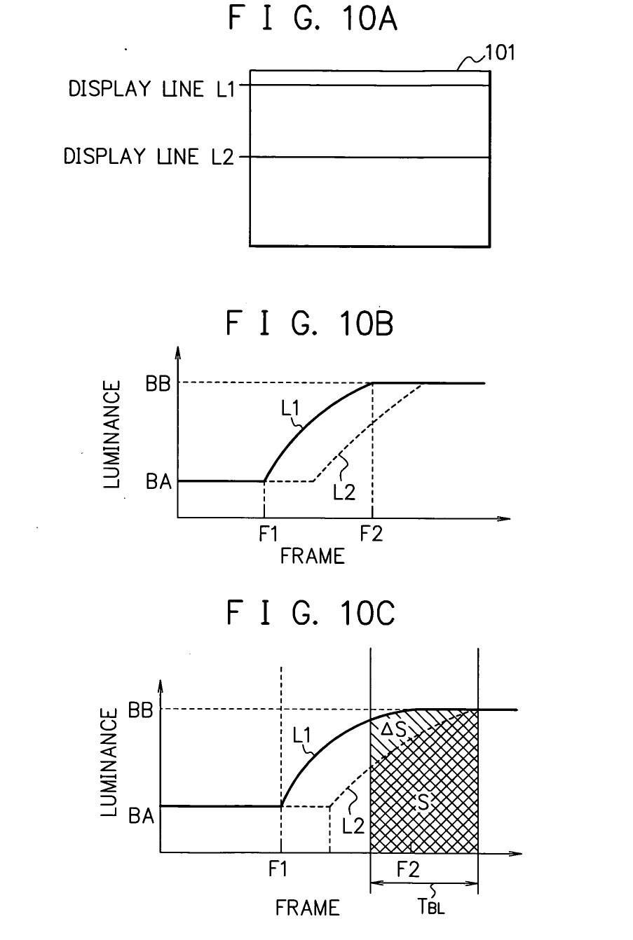

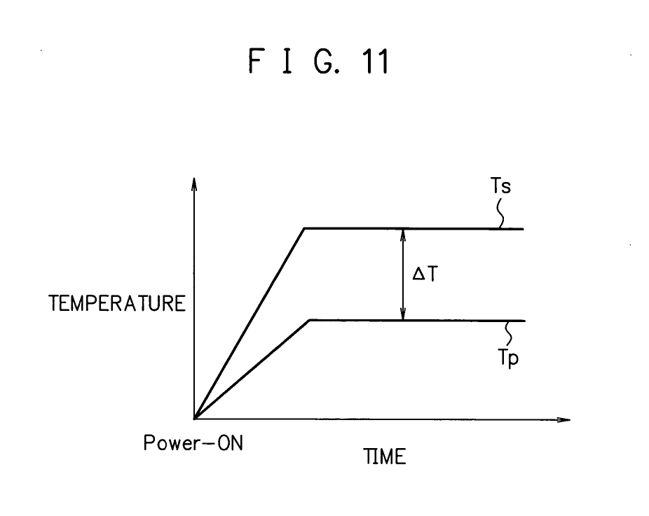

The data correction amount is adjusted as shown in FIG. 5. Accordingly, during a backlight-on period T_{BL}, an amount of light of the display line L1 is S+ΔS1, and an amount of light of the display line L2 is S+ΔS2, so that a difference in the total amount of light results in (ΔS1−ΔS2). Further, in FIG. 5, since the data correction amount in the display line L2 is made in an increasing direction, ΔS1 is smaller than ΔS shown in FIG. 10C. Moreover, since ΔS2 is plus, (ΔS1−ΔS2)<ΔS, which means the difference in luminance between the display lines is reduced. This can realize improved response speed of liquid crystal in the liquid crystal display device.

Incidentally, the adjustment of the data correction amount in the third embodiment can be realized by the same configuration as that of the image/timing processing section 4 shown in FIG. 2. The data correction amount of several display lines may be increased by one as a unit according to at least light or the like of backlights and according to properties. Further, such a configuration may be adopted that the display part is divided to a plurality of blocks, data correction amounts optimum for the respective blocks are stored in advance as a table in a storage element such as a memory to read the optimum table. It should be noted that this is not restrictive and an arbitrary data correction amount adjusting method may be adopted.

—Fourth Embodiment—

Next, a fourth embodiment of the present invention will be explained.

The fourth embodiment to be explained below is to solve the aforesaid fourth problem.

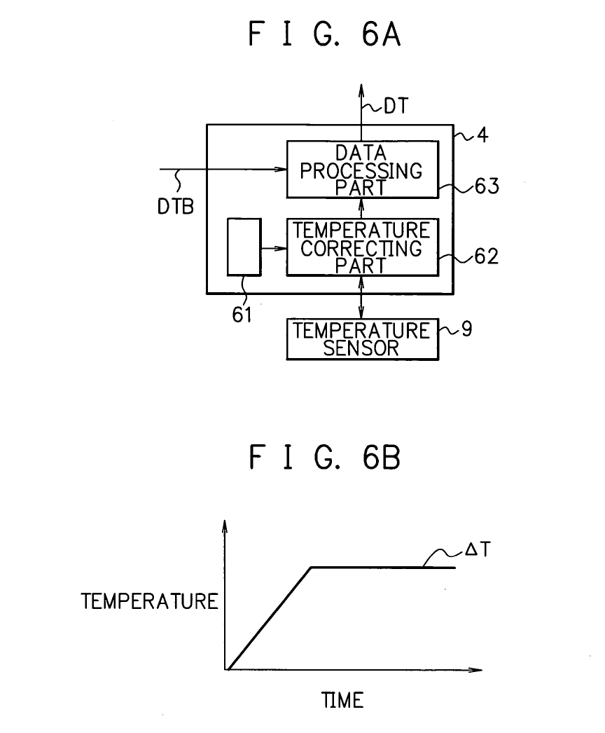

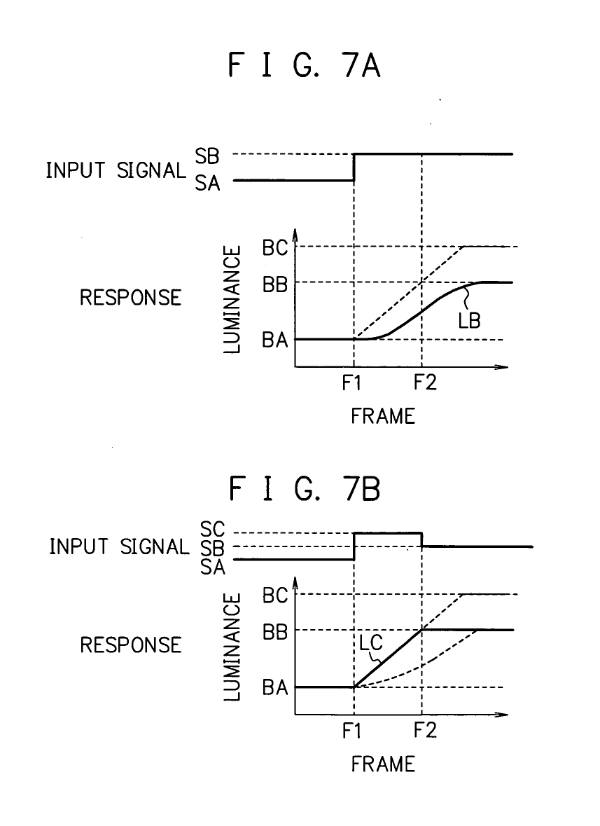

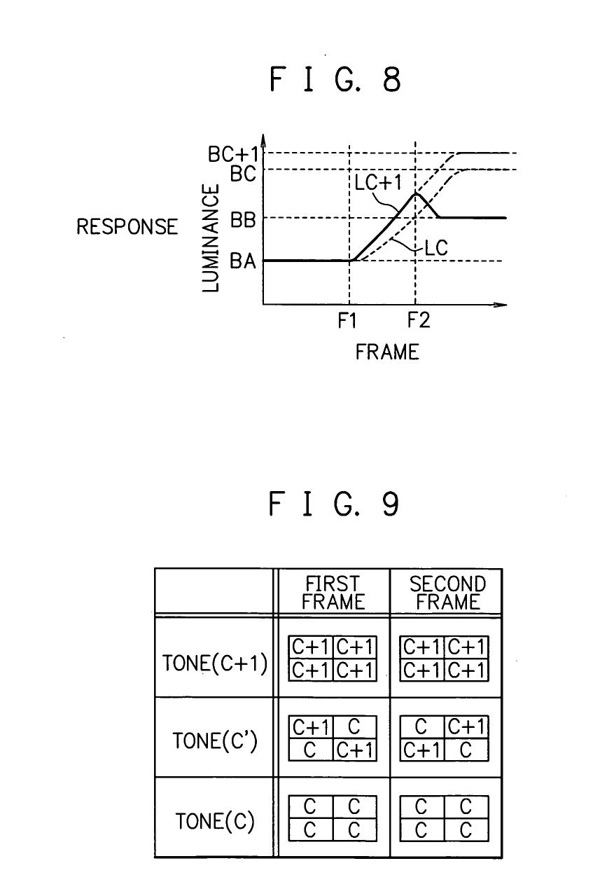

FIG. 6A is a diagram showing a configuration example of an image/timing processing section 4 in the fourth embodiment. The image/timing processing section 4 has an oscillation circuit 61, a temperature correcting part 62, and a data processing part 63 having the function of the comparator 22 shown in FIG. 2.

The oscillation circuit 61 is intended for measuring the lapsed time after power is turned on.

The temperature correcting part 62 determines a temperature difference ΔT between a temperature of a panel surface and a temperature detected by a temperature sensor 9, based on the lapsed time from the power-on time which is inputted from the oscillation circuit 61. Then, the temperature correcting part 62 corrects the temperature detected by the temperature sensor 9 based on the temperature difference ΔT and outputs the corrected temperature to the data processing part 63. The temperature difference ΔT is determined by referring to the correlation, which are stored in advance, between the lapsed time and the temperature difference ΔT as shown in FIG. 6B.

The data processing part 63 compares data of a frame (n−1) stored in a memory 8 and image data DTB of a frame n, and, based on the comparison result, subjects the image data DTB of the frame n to data correction for improving response speed and outputs the corrected data as data DT. At this time, the data processing part 63 makes the data correction in consideration of the corrected temperature supplied from the temperature correcting part 62.

As described above, according to the fourth embodiment, the temperature difference ΔT between the temperature of the panel surface and the temperature detected by the temperature sensor 9 is set so as to change according to the lapsed time from the power supply time as shown in FIG. 6B. Consequently, the aforesaid fourth problem is solved, so that it is possible to constantly make proper data correction from the power supply time. This can realize improved response speed of liquid crystal in the liquid crystal display device.

As explained hitherto, according to the present invention, at least one of the output corresponding to the maximum tone and the output corresponding to the minimum tone in the data driver of the liquid crystal display device is used only for image data that has undergone data correction for improving response speed of liquid crystal. Consequently, data correction for improving response speed can be made in all areas. This can realize improved response speed of the liquid crystal in the liquid crystal display device.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A liquid crystal display device configured to compare inputted image data and image data of a preceding frame and subject the inputted image data to data correction for improving response speed of liquid crystal based on a result of the comparison, comprising
a data driver,
wherein at least one of an output corresponding to a maximum tone and an output corresponding to a minimum tone in said data driver is used for only the image data that has undergone the data correction.

2. The liquid crystal display device according to claim 1,
wherein the output corresponding to the maximum tone and the output corresponding to the minimum tone are used only for the image data that has undergone the data correction.

3. The liquid crystal display device according to claim 1,
wherein tones that said data driver is capable of outputting from all outputs are displayed by arbitrarily combining all the outputs of said data driver except the output corresponding to the tone used only for the image data that has undergone the data correction.

4. The liquid crystal display device according to claim 3, further comprising
a table in which the tones that said data driver is capable of outputting are shown so as to be related to the combinations of the outputs of said data driver except the output corresponding to the tone used only for the image data that has undergone the data correction.

5. The liquid crystal display device according to claim 3, wherein an error diffusion method is applied to the combinations of the outputs of said data driver except the output corresponding to the tone used only for the image data that has undertone the data correction.

6. The liquid crystal display device according to claim 1, wherein said data driver is capable of outputting, in addition to outputs corresponding to all tones designatable by the image data, at least one of an output corresponding to a higher luminance than a luminance of the maximum tone and an output corresponding to a lower luminance than a luminance of the minimum tone.

7. The liquid crystal display device according to claim 6, wherein as at least one of the output corresponding to the higher luminance than the luminance of the maximum tone and the output corresponding to the lower luminance than the luminance of the minimum tone, a plurality of outputs corresponding to luminances different from each other are allowed to be outputted.

8. A data driver being capable of outputting, in addition to outputs corresponding to all tones designatable by inputted image data, at least one of an output corresponding to a higher luminance than a luminance of a maximum tone and an output corresponding to a lower luminance than a luminance of a minimum tone.

9. A liquid crystal display device configured to compare inputted image data and image data of a preceding frame and subject the inputted image data to data correction for improving response speed of liquid crystal based on a result of the comparison, comprising
a processing part configured to process the image data to increase a luminance level,
wherein in said processing part, processing of the image data that has undergone the data correction is prohibited.

10. A liquid crystal display device configured to compare inputted image data and image data of a preceding frame and subject the inputted image data to data correction for improving response speed of liquid crystal based on a result of the comparison, comprising
a backlight that is impulse-driven,
wherein a correction amount in the data correction is changed by a unit of at least one horizontal line or more.

11. A liquid crystal display device, configured to compare inputted image data and image.data of a preceding frame and subject the inputted image data to data correction for improving response speed of liquid crystal based on a result of the comparison, a correction amount in the data correction being changed according to a temperature, comprising
a temperature measuring part,
wherein a temperature measured in said temperature measuring part is corrected by a temperature correction amount that varies with time, during a period from a power supply time to a temperature stable time.

12. A driving method of a liquid crystal display device, comprising:
a first step of comparing inputted image data and image data of a preceding frame; and
a second step of subjecting the inputted image data to data correction for improving response speed of liquid crystal based on a result of the comparison,
wherein at least one of an output corresponding to a maximum tone and an output corresponding to a minimum tone in a data driver is used only for the image data that has undergone the data correction.

13. The driving method of the liquid crystal display device according to claim 12,
wherein the output corresponding to the maximum tone and the output corresponding to the minimum tone are used only for the image data that has undergone the data correction.

14. The driving method of the liquid crystal display device according to claim 12, wherein tones that the data driver is capable of outputting from all outputs are displayed by arbitrarily combining all the outputs of the data driver except the output corresponding to the tone used only for the image data that has undergone the data correction.
